(19) United States
(12) Patent Application Publication
(10) Pub. No.: US 2009/0314515 A1
(43) Pub. Date: Dec. 24, 2009

(54) Folding cord with rigid sections and magnets

(76) Inventors: Joeben BEVIRT, Santa Cruz, CA (US); Freditalo Polito, Santa Cruz, CA (US)

Correspondence Address: MICHAEL A. GUTH, 2-2905 EAST CLIFF DRIVE, SANTA CRUZ, CA, 95062, US

(21) Appl. No.: 12/214,797

(22) Filed: Jun. 20, 2008

(51) Int. Cl. H01B 3/00

(52) U.S. Cl. 174/110 R

(57) ABSTRACT

An apparatus for the compact and neat storage of electrical cords, such as power extension cords and cords for earplugs and other devices. The cord may have repeating rigid sections which allow for the easy folding and grouping of the sections to allow for organized collection of portions of the cable which are not needed to be extended while in use, as well as for the organized collection of the entire cable when not in use. The rigid sections may have magnets which promote the organized grouping of the sections when collected together.

### BACKGROUND

1. Field of the Invention

This invention relates to organizing electrical cords and other wiring.

2. Description of Related Art

Manufacturers generally ship products that have electrical power cords with the cords neatly bundled and secured to minimize shipping space and to present a neat and attractive package to the consumer. Most consumers are familiar with the standard manner that manufacturers use to bundle electrical cords with new appliances and the like; the power cord is neatly folded over onto itself in an accordion like manner into a bundle that is tightly secured near the center of the bundle with a tie wire or other similar tying device. With power cords folded back over themselves in this familiar manner and the folded cord tied near the center point of the bundle, the cord is held in a bundle that is shaped somewhat like a figure eight; the center of the bundle where the tie wire is located is constricted relative to the outer ends of the bundle where the cord is folded over on itself.

Most consumers will also recognize that once the original tie wire that secures the bundled cord is undone, it is very difficult to re-bundle the cord. Indeed, once the originally bundled cord is untied, that may be the last time the cord is ever so neatly organized.

With the advent of telecommunications devices the number of cords used in homes and businesses has increased dramatically. In addition, personal electronic devices are prevalent which a user may carry at all times.

What is called for is a device and method for neatly organizing cords in a manner that is repeatable. What is also called for is such a device which is useful when the cord is in use as well as when stored between uses.

### SUMMARY

An apparatus for the compact and neat storage of electrical cords, such as power extension cords and cords for earplugs and other devices. The cord may have repeating rigid sections which allow for the easy folding and grouping of the sections to allow for organized collection of portions of the cable which are not needed to be extended while in use, as well as for the organized collection of the entire cable when not in use. The rigid sections may have magnets which promote the organized grouping of the sections when collected together.

### BRIEF DESCRIPTION OF THE DRAWINGS

FIG. 1A is an illustration of a folding cable with flat segments according to some embodiments of the present invention.

FIG. 1B is an illustration of a folding cable with flat segments according to some embodiments of the present invention.

FIG. 2A is an illustration of a folding cable with round segments according to some embodiments of the present invention.

FIG. 2B is an illustration of a folding cable with round segments according to some embodiments of the present invention.

FIG. 3A is an illustration of a folding cable and container according to some embodiments of the present invention.

FIG. 3B is an illustration of a folding cable and container according to some embodiments of the present invention.

FIG. 4 is an illustration of a power cord with folding segments according to some embodiments of the present invention.

FIG. 5 is an illustration of a power cord with alternating rigid and soft segments according to some embodiments of the present invention.

FIG. 6A is an illustration of a portion of a power cord with a thick portion according to some embodiments of the present invention.

FIG. 6B is an illustration of a portion of a power cord with thicker portions according to some embodiments of the present invention.

FIG. 7A is an illustration of an exploded view of a cable with embedded magnets according to some embodiments of the present invention.

FIG. 7B is an illustration of a cable with embedded magnets according to some embodiments of the present invention.

FIG. 8 is an illustration of a cable with magnetic rings according to some embodiments of the present invention.

FIG. 9 is an illustration of a cable with magnetic beads according to some embodiments of the present invention.

FIG. 10A is an illustration of a portion of a cable with flex joints according to some embodiments of the present invention.

FIG. 10B is an illustration of a cable with flex joints according to some embodiments of the present invention.

FIG. 11A is an illustration of a portion of a cable with hook and loop fasteners according to some embodiments of the present invention.

FIG. 11B is an illustration of a cable with hook and loop fasteners according to some embodiments of the present invention.

### DETAILED DESCRIPTION

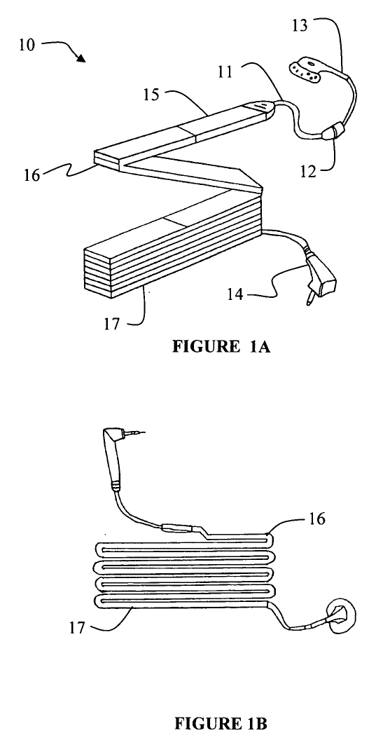

FIGS. 1A and 1B are illustrations of a folding cable assembly 10 according to some embodiments of the present invention. A wire or plurality of wires adapted to carry electrical current or signal form a cable 11. A plug 14 is found on a first end of the cable assembly, and a plug or jack 12 is found on the second end of the cable assembly. In some embodiments, male plugs may be found on one or both ends of the cable assembly. In some embodiments, female plugs may be found on one or both ends of the cable assembly. In some embodiments, other features or simple wire ends may be found on one or both ends of the cable assembly. An earpiece 13 is attached to plug 12, such that cable assembly 10 as illustrated could be used as a wired ear plug for use with an audio player or other device.

A collection 17 of segments 15 is seen assembled from a series of segments 15 which have flexible portions 16 between them. The segments 15 are adapted to allow for bending of the cable assembly at the flexible portions 16, allowing for the organized stacking of the segments in a compact fashion. In some embodiments, the segments may be relatively flat and of rectangular cross section. The segments 15 may be rigid or semi-rigid, thus allowing the user to quickly take an extended cable assembly and pack it in a compact, organized fashion for storage or transport. Also, during use the portion of the cable assembly not needed for extension in a given logistic situation may be kept organized and compactly stored. The segments 15 may be comprised of stiffening elements which may formed as part of the process of creating the cable, or may be added after the formation of the base cable through molding, adhesion, or other processes.

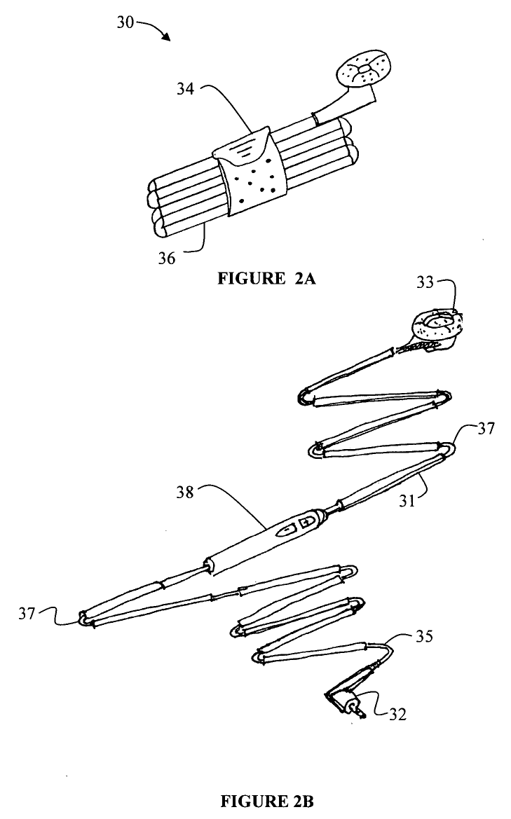

FIGS. 2A and 2B are illustrations of a folding cable assembly 30 according to some embodiments of the present invention. A wire or plurality of wires adapted to carry electrical current or signal form a cable 35. A plug 32 is found on a first end of the cable assembly, and an earpiece 33 is found on the second end of the cable assembly. In some embodiments, male plugs may be found on one or both ends of the cable assembly. In some embodiments, female plugs may be found on one or both ends of the cable assembly. In some embodiments, other features or simple wire ends may be found on one or both ends of the cable assembly. A switching segment 38 is found within the cable assembly, allowing for switching on or off, and/or volume control, of the earpiece.

A collection 36 of segments 31 is seen assembled from a series of segments 31 which have flexible portions 37 between them. The segments 31 are adapted to allow for bending of the cable assembly at the flexible portions 37, allowing for the organized stacking of the segments in a compact fashion. In some embodiments, the segments may be of round or relatively round cross section. The segments may be a wire portion surrounded by a rigid portion in some embodiments. The segments 31 may be comprised of stiffening elements which may formed as part of the process of creating the cable, or may be added after the formation of the base cable through molding, adhesion, or other processes.

The segments 31 may be rigid or semi-rigid, thus allowing the user to quickly take an extended cable assembly and pack it in a compact, organized fashion for storage or transport. Also, during use the portion of the cable assembly not needed for extension in a given logistic situation may be kept organized and compactly stored.

A wrap portion 34 may be used to retain the collected segments to aid in storage such that the collected segments do not fan out from each other. The wrap portion 34 may be a flexible material in some embodiments. The wrap portion may fasten with a snap or hook and loop fasteners in some embodiments.

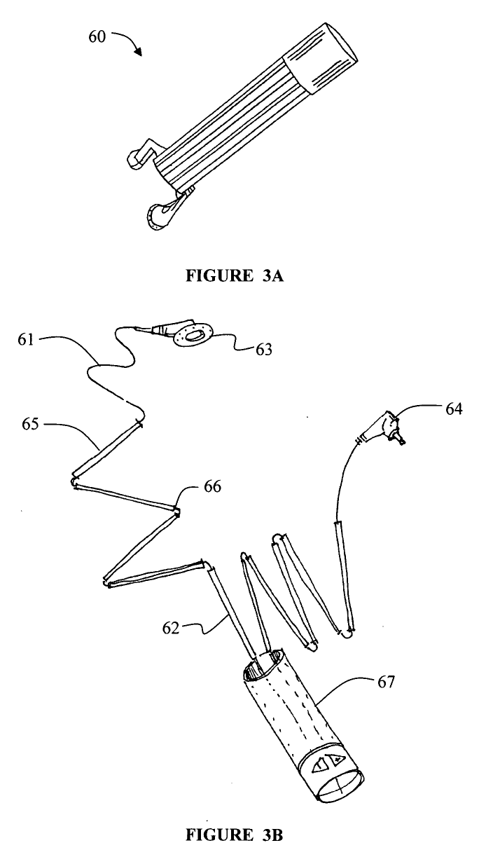

FIGS. 3A and 3B are illustrations of a folding cable assembly 60 according to some embodiments of the present invention. A wire or plurality of wires adapted to carry electrical current or signal form a cable 61. A plug 64 is found on a first end of the cable assembly, and an earpiece 63 is found on the second end of the cable assembly. In some embodiments, male plugs may be found on one or both ends of the cable assembly. In some embodiments, female plugs may be found on one or both ends of the cable assembly. In some embodiments, other features or simple wire ends may be found on one or both ends of the cable assembly.

A collection 62 of segments 65 is seen assembled from a series of segments 65 which have flexible portions 66 between them. The segments 65 are adapted to allow for bending of the cable assembly at the flexible portions 66, allowing for the organized stacking of the segments in a compact fashion. In some embodiments, the segments may be of round or relatively round cross section. The segments may be a wire portion surrounded by a rigid portion in some embodiments. The segments 65 may be rigid or semi-rigid, thus allowing the user to quickly take an extended cable assembly and pack it in a compact, organized fashion for storage or transport. Also, during use the portion of the cable assembly not needed for extension in a given logistic situation may be kept organized and compactly stored. A storage sleeve 67 may be used to retain the collected segments to aid in storage such that the collected segments do not fan out from each other.

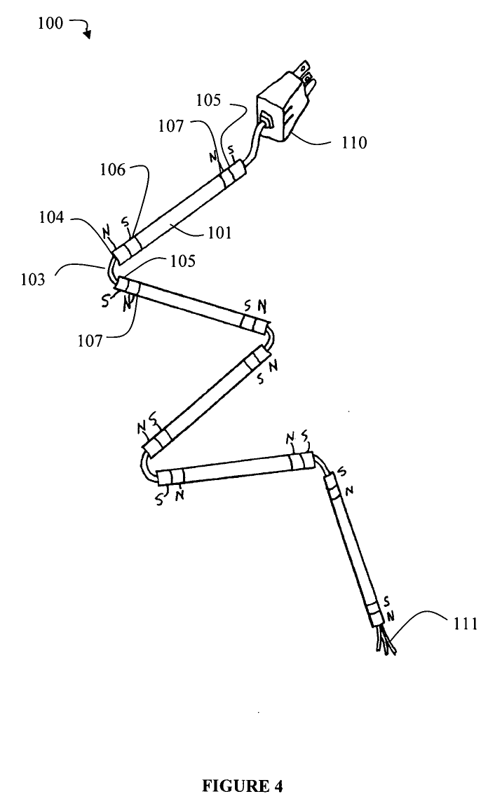

FIG. 4 illustrates portions of a folding cable assembly 100 according to some embodiments of the present invention. The folding cable assembly 100 utilizes magnets to aid in the organized collection and stacking of the segments when folded into a compact assembly. The cable assembly has a first end which may have a plug 110 and a second end 111 which may have another plug, or other end type. A plurality of rigid segments 101 may utilize magnetic force to facilitate the close stacking of the segments and collection of segments with some adhesion to each other. In some embodiments, the segments 101 may alternate in a way that promotes magnetic adhesion. For example, in some embodiments, the segments may alternate in their poles such that successive segments along the length of the cable adhere well to each other. A segment 101 may have a south pole portion 105 and then a north pole portion 107 at a first end, and then a north pole portion 104 and south pole portion 106 at a second end, where the placement of the pole portions allow for stacking of the segments 101 when bent at the flexible portions 103. In some embodiments, the magnetic and/or magnetically permeable portions may be part of a longer stiffening element. In some embodiments, the magnetic and/or magnetically permeable portions may not be on the ends of the segments but may be at a different location along the segments.

In some embodiments of the present invention the cable assembly segments may alternate across each flexible portion between segments such that there may be a magnet on one end and a metallic portion on the other. The alternation of pole placement of magnet/metal placement will be such that the segments are adapted to easily adhere to the next segment, aiding in easy collection of segments into grouping which is compact, yet is also easily un-collected to allow for the re-stretching out of the cable.

One advantage of alternating the polarity of the mating magnets is to reduce or eliminate the possibility of triangulating the portions. Instead of a first section adjacent to a second section laying together, and flat, there may be a possibility that the far end of the third section may adhere to the far end of the second section, creating in essence an equilateral triangle out of the three joined sections, instead of three sections laying flat together.

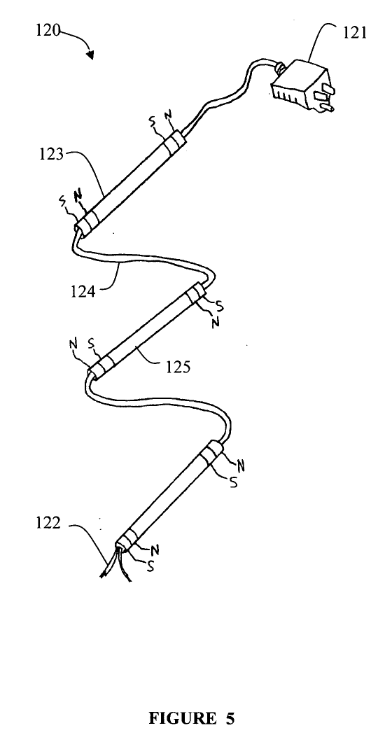

In some embodiments of the present invention, as seen in FIG. 5, the cable assembly 120 has segments 123, 125 interspersed with segments 124 which may not have a magnetic portion or a magnetically permeable portion, and may also not have a stiffening element in some embodiments. The segments 123, 125, may have their poles placed differently to allow for good adhesion in some embodiments. In some embodiments, there may be an alteration between magnetic and metallic, or magnetically permeable, segments, with regular cable segments in between the alternating segments. The cable assembly has a first end which may have a plug 121 and a second end 122 which may have another plug, or other end type.

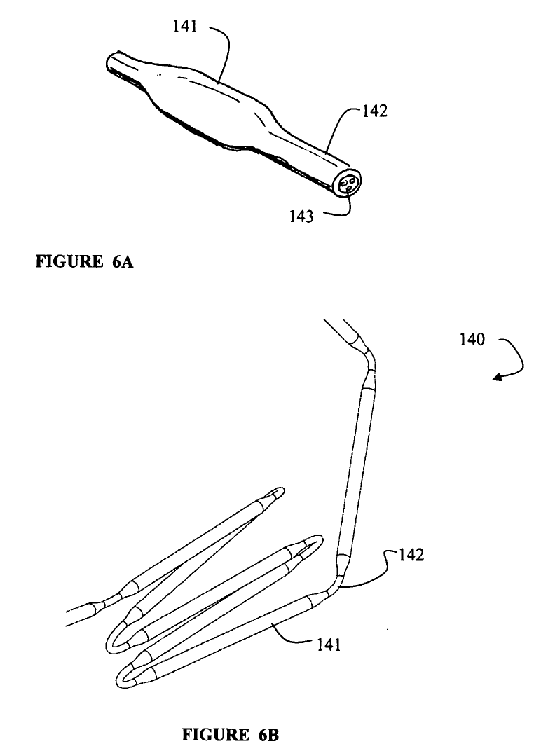

In some embodiments of the present invention, as seen in FIGS. 6A-B, a cable assembly 140 has a plurality of stiffer segments 141 interspersed with more flexible portions 142. In some embodiments, the flexible portions 142 may be a wire or wires 143 with insulation around them. The stiffer segments may be of a thicker insulation in this area. In some embodiments, the thickness of the insulation, or other type of outer layer, may be varied during an extrusion process. The alternating thicker portions with the flexible portions allows for easier and more organized collection of the wire for storage, or for collection of the unused, unextended portion of the wire while in use. In some embodiments, the alternating thicker and thinner segments may also use magnets as seen in other embodiments of the present invention.

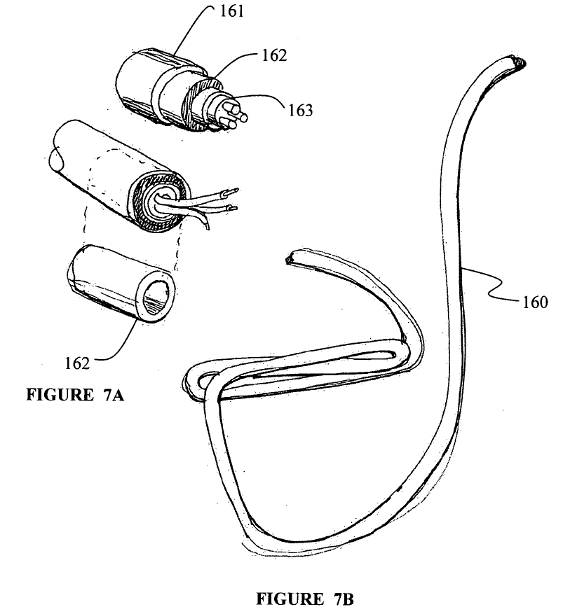

In some embodiments of the present invention, as seen in FIGS. 7A-B, a cable assembly 160 may have magnets embedded within it along its length. In some embodiments, there may be magnets 162 around the wires 163 but within the outer layer 161 at certain intervals. In some embodiments, there may be a continuous flexible magnet band. In some embodiments, the outer layer 161 of the cable assembly 160 may be of continuous outer diameter.

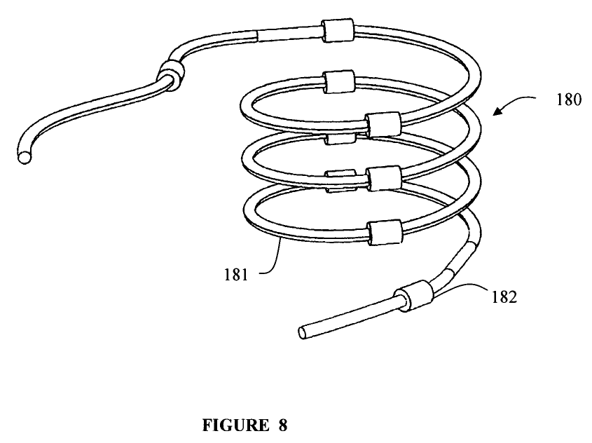

In some embodiments of the present invention, as seen in FIG. 8, a cable assembly 180 may have magnets 182 attached along the length of the cable 181. The magnets 182 may be rings of an annular cylindrical shape in some embodiments. In some embodiments, the rings may have a gap to allow for attachment onto the cable 181. In some embodiments, the rings may be swaged on, or attached with other process. In some embodiments, the rings may be bonded onto the cable, and may be of more than one piece prior to bonding. In some embodiments, the cable may have a preset set into one of its layers such that it is adapted to easily be put into a helix shape, or other shape adapted to allow the stowage of the cable and the adherence of the magnets to each other or to magnetically permeable material along the cable.

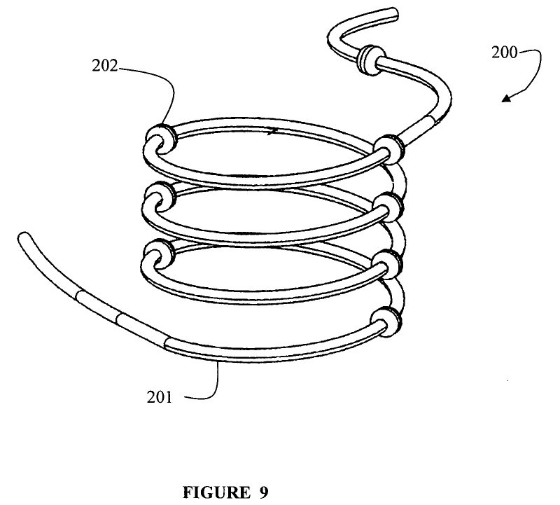

In some embodiments of the present invention, as seen in FIG. 9, a cable assembly 200 may have magnets 202 attached along the length of the cable 201. The magnets 202 may be beads of a spherical or oval shape in some embodiments. In some embodiments, the beads 202 may have a gap to allow for attachment onto the cable 201. In some embodiments, the rings may be swaged on, or attached with other process. In some embodiments, the beads may be bonded onto the cable, and may be of more than one piece prior to bonding.

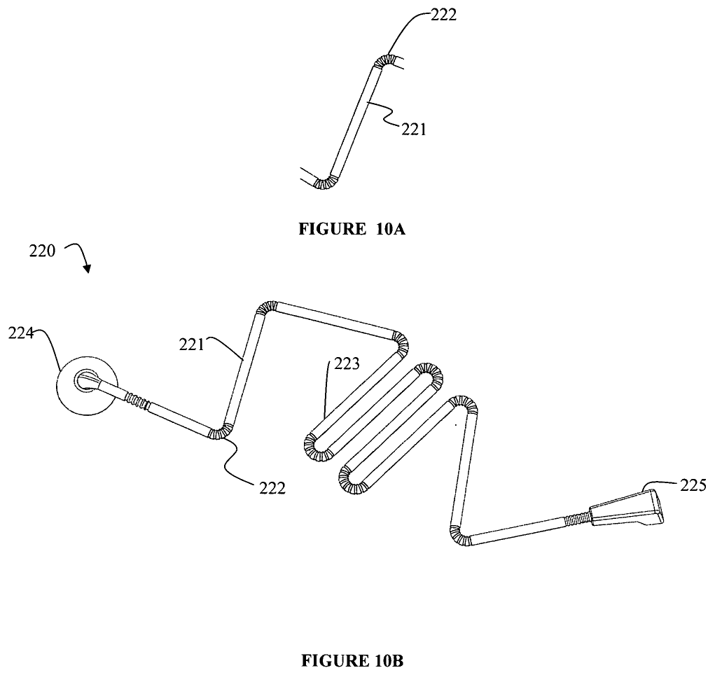

FIGS. 10A-B are illustrations of a folding cable assembly 220 according to some embodiments of the present invention. A wire or plurality of wires adapted to carry electrical current or signal form a cable. A plug 225 is found on a first end of the cable assembly, and an earpiece 224, plug, or jack is found on the second end of the cable assembly. In some embodiments, male plugs may be found on one or both ends of the cable assembly. In some embodiments, female plugs may be found on one or both ends of the cable assembly. In some embodiments, other features or simple wire ends may be found on one or both ends of the cable assembly.

A collection 223 of segments 221 is seen assembled from a series of segments 221 which have flexible portions 222 between them. The segments 221 are adapted to allow for bending of the cable assembly at the flexible portions 222, allowing for the organized stacking of the segments in a compact fashion. In some embodiments, the flexible portions 222 may be of a corrugated nature which allow for bending. The segments 221 may be rigid or semi-rigid, thus allowing the user to quickly take an extended cable assembly and pack it in a compact, organized fashion for storage or transport. Also, during use the portion of the cable assembly not needed for extension in a given logistic situation may be kept organized and compactly stored. The segments 221 may be comprised of stiffening elements which may formed as part of the process of creating the cable, or may be added after the formation of the base cable through molding, adhesion, or other processes. In some embodiments, there may be magnets along cable assembly 220 as well.

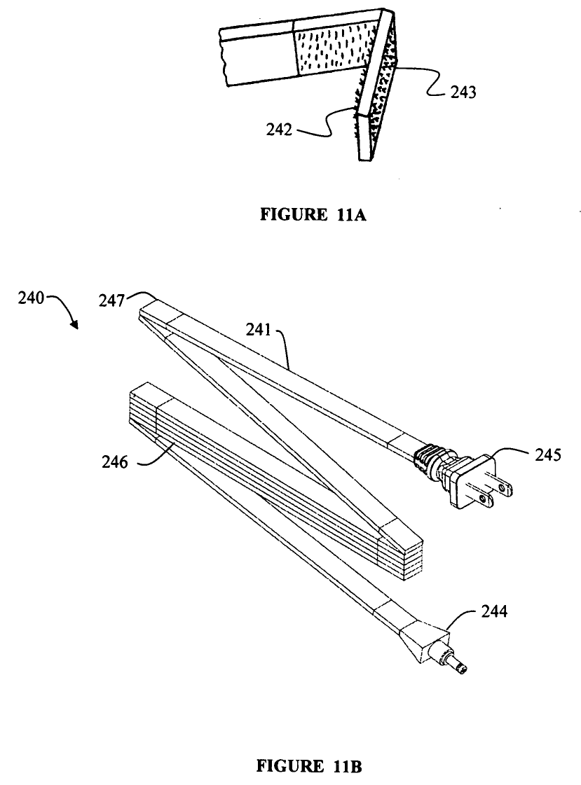

FIGS. 11 A-B are illustrations of a folding cable assembly 240 according to some embodiments of the present invention. A wire or plurality of wires adapted to carry electrical current or signal form a cable. A plug 244 is found on a first end of the cable assembly, and a plug or jack 245 is found on the second end of the cable assembly. In some embodiments, male plugs may be found on one or both ends of the cable assembly. In some embodiments, female plugs may be found on one or both ends of the cable assembly. In some embodiments, other features or simple wire ends may be found on one or both ends of the cable assembly.

A collection 246 of segments 241 is seen assembled from a series of segments 241 which have flexible portions 247 between them. The segments 241 are adapted to allow for bending of the cable assembly at the flexible portions 247, allowing for the organized stacking of the segments in a compact fashion. In some embodiments, the segments may be relatively flat and of rectangular cross section. The segments 241 may be rigid or semi-rigid, thus allowing the user to quickly take an extended cable assembly and pack it in a compact, organized fashion for storage or transport. Also, during use the portion of the cable assembly not needed for extension in a given logistic situation may be kept organized and compactly stored. The segments 241 may be comprised of stiffening elements which may formed as part of the process of creating the cable, or may be added after the formation of the base cable through molding, adhesion, or other processes. In some embodiments, a series of hook and loops fasteners 242, 243 may be affixed to the segments 241 to allow for firmer holding of the collection 246 of segments 241. The hook and loop fasteners may be on the ends of the segments, or at other points along the segments.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A segmented electrical cord, said segmented electrical cord comprising:
an electrical cord, said electrical cord having a first end and a second end; and
a plurality of stiffening elements, each of said stiffening elements attached along said electrical cord.

2. The segmented electrical cord of claim 1 wherein said stiffening elements comprise a first side and a second side, and wherein said first side and said second side are substantially flat.

3. The segmented electrical cord of claim 2 further comprising a plurality of flexible portions, each of said flexible portions located between two stiffening elements.

4. The segmented electrical cord of claim 3 wherein said stiffening elements are adapted to stack upon each other.

5. The segmented electrical cord of claim 4 further comprising hook and loop fasteners, said hook and loop fasteners attached along said stiffening elements, said hook and loop fasteners adapted to fasten when said stiffening elements are stacked upon each other.

6. The segmented electrical cord of claim 4 further comprising a wrap portion, said wrap portion comprising a fastener, said wrap portion adapted to fasten around said stiffening elements when said stiffening elements are stacked upon each other.

7. The segmented electrical cord of claim 4 further comprising a storage sleeve, said storage sleeve adapted to hold said stiffening elements when said stiffening elements are stacked upon each other.

8. The segmented electrical cord of claim 1 wherein said stiffening elements comprise a first side and a second side, and wherein said first side and said second side are substantially round.

9. The segmented electrical cord of claim 8 further comprising a plurality of flexible portions, each of said flexible portions located between two stiffening elements.

10. The segmented electrical cord of claim 9 wherein said stiffening elements are adapted to fold upon each other into a group of elements.

11. The segmented electrical cord of claim 10 further comprising a wrap portion, said wrap portion comprising a fastener, said wrap portion adapted to fasten around said stiffening elements when said stiffening elements are grouped with each other.

12. The segmented electrical cord of claim 10 further comprising a storage sleeve, said storage sleeve adapted to hold said stiffening elements when said stiffening elements are grouped with each other.

13. A segmented electrical cord assembly comprising:
an electrical cord, said electrical cord having a first end and a second end;
a plurality of stiffening elements, each of said stiffening elements attached along said electrical cord; and
a plurality of magnets, each of said plurality of magnets attached to a stiffening element.

14. The segmented electrical cord assembly of claim 13 further comprising a plurality of flexible portions, each of said flexible portions located between two stiffening elements.

15. The segmented electrical cord of claim 14 further comprising a plurality of magnetically permeable portions, each of said plurality of magnetically permeable portions attached to a stiffening element.

16. The segmented electrical cord of claim 15 wherein said magnets and said magnetically permeable portions are attached along said electrical cord in an alternating pattern.

17. The segmented electrical cord assembly of claim 14 wherein each of said plurality of magnets is attached to an end of a stiffening element.

18. The segmented electrical cord assembly of claim 14 wherein each of said stiffening elements has a magnet attached to it.

19. The segmented electrical cord assembly of claim 17 wherein said stiffening elements are adapted to fold over at said flexible portions and magnetically adhere to each other.

20. An electrical cord having a first end and a second end, said electrical cord comprising:
one or more electrical conductors, electrical conductors having a first end and a second end; and
an outer sheath, said outer sheath comprising:
a first plurality of thicker sections; and
a second plurality of thinner sections, wherein at least some of said second plurality of thinner sections are located between a pair of thicker sections along the length of said electrical cord.

21. The electrical cord of claim 20 wherein said first plurality of thicker sections and said second plurality of thinner sections are made from the same material.

22. The electrical cord of claim 20 wherein said thicker sections are substantially longer than said thinner sections.

23. The electrical cord of claim 20 further comprising a plurality of magnets, wherein said magnets are attached along said electrical cord.

24. The electrical cord of claim 23 wherein said plurality of magnets are attached to one or more of said plurality of thicker sections of said outer sheath of said electrical cord.

25. The electrical cord of claim 24 wherein said magnets are attached to said thicker sections of said outer sheath at an end of the thicker sections.

26. An electrical cord assembly comprising:
an electrical cord, said electrical cord having a first end and a second end;
a plurality of magnetic elements, each of said magnetic elements attached along said electrical cord.

27. The electrical cord assembly of claim 26 wherein said electrical cord has an outer sheath, and wherein said plurality of magnetic elements are embedded in said outer sheath.

28. The electrical cord assembly of claim 27 wherein said magnetic elements are intermittently spaced along said electrical cord.

29. The electrical cord assembly of claim 26 wherein said electrical cord wherein said electrical cord has an outer sheath, and wherein said plurality of magnetic elements are intermittently space along the exterior of said outer sheath.

30. The electrical cord assembly of claim 29 wherein said plurality of magnetic elements have an external cylindrical shape, and wherein said electrical cord runs through a hole within the magnetic element.

31. The electrical cord assembly of claim 29 wherein said plurality of magnetic elements have an external spherical shape, and wherein said electrical cord runs through a hole within the magnetic element.

32. The electrical cord assembly of claim 29 wherein said plurality of magnetic elements have an external oval shape, and wherein said electrical cord runs through a hole within the magnetic element.
